(19) United States
(12) Patent Application Publication
(10) Pub. No.: US 2017/0168920 A1
(43) Pub. Date: Jun. 15, 2017

(54) TRANSFER OF PAYLOAD DATA

(71) Applicant: dSPACE digital signal processing and control engineering GmbH, Paderborn (DE)

(72) Inventors: Matthias WERTH, Paderborn (DE); Jobst RICHERT, Lippstadt (DE)

(73) Assignee: dSPACE digital signal processing and control engineering GmbH, Paderborn (DE)

(21) Appl. No.: 15/367,216

(22) Filed: Dec. 2, 2016

Related U.S. Application Data
(60) Provisional application No. 62/265,112, filed on Dec. 9, 2015.

(51) Int. Cl. G06F 11/36; G06F 9/44

(52) U.S. Cl. CPC G06F 11/3664; G06F 8/70

(57) ABSTRACT

A transfer of payload data from a buffer to a destination data store is provided so that the data can be processed there by a computer-assisted development environment. To this end, a data management environment provides the buffer and the destination data store. A data record having the payload data and semantic data that are associated with the payload data is provided in the buffer, and a data object with processing-specific object semantics is provided in the destination data store. The data object is instantiated with the payload data by means of the semantic data in that the payload data are placed in the data object as a function of the object semantics of the data object in such a manner that the development environment can process the payload data on the basis of the object semantics.

This nonprovisional application claims priority to U.S. Provisional Application No. 62/265,112, which was filed on Dec. 9, 2015, and which is herein incorporated by reference.

### BACKGROUND OF THE INVENTION

Field of the Invention

The present invention relates to a method for the transfer of payload data from a buffer to a destination data store, and also concerns a data storage environment having a buffer and a destination data store.

Description of the Background Art

The transfer of payload data from a data-generating source device to a destination device that performs further processing, and the subsequent further processing of this data, requires information about the semantics of the payload data, which is to say about the technical context of the source device from which the payload data originate, and about the meaning of the data.

To this end, the payload data are generally transferred together with semantic information that describes the technical context in which the payload data are generated or prepared by the source device. The destination device can then interpret and process the payload data in accordance with the dictates of the semantic information. Alternatively, the payload data can also be transferred without semantic information if a predefined semantic data convention that conveys the technical context of the payload data is known to the destination device.

Such semantic information can be, for example, mnemonic (expressive) or generic identifiers or variable names that convey the context or the meaning of the payload data within the source device such that the destination device can correctly interpret the payload data. In the case of more complex data structures, which combine payload data having related content into data records, semantic information in the form of attributes makes it possible to identify and distinguish data records of the same type.

In addition, software programs, for example scripts or the like, are also oftentimes used that, as much as possible, map the payload data provided in a data record by the source device to the technical context of the destination device based on the semantic information. In so doing, the semantic information is examined automatically for attributes, identifiers, or components of attributes or identifiers that allow classification into the context of the destination device. In technical terms, however, this process entails a great deal of development and adaptation effort with regard to the scripts for evaluation, since the interpretation of the payload data is merely being shifted from the data level to the script level in this process, and conventions are needed here, as well, for example concerning the structure of the data records and the payload data to be found therein. The reason for this is that if multiple data records are transferred and a specific identifier is to be identified, it may initially be unclear which of the data records contains the identifier in question.

These problems are further exacerbated in the case of software development projects in which multiple source and/or destination devices are involved, generally with different data requirements. One possible example of this is the process of distributed, computer-assisted development, testing, and/or simulation of software models of technical systems, or of parts of such a system, in a distributed development environment, for instance in control unit modeling or control unit architecture modeling, virtual control unit validation, HIL (hardware-in-the-loop) simulation, or rapid control prototyping (RCP).

In such complex and many-layered development projects, the semantics of the data records to be transferred can only undergo script-based analysis to a very limited extent without it being necessary to agree on a semantic convention or to integrate comprehensive semantic/technical knowledge about the diverse data requirements of the various source and destination devices into the scripts, for example concerning what payload data are identified and/or structured in a data record that carries specific attributes and how this is done. Oftentimes the situation is intensified by additional technical and organizational problems, such as, e.g., the assignment of access rights, the appropriate hardware and software architecture, and the like.

### SUMMARY OF THE INVENTION

It is therefore an object of the present invention to provide a solution for the transfer of payload data that avoids the stated problems and also additional problems.

The present invention concerns, in an exemplary embodiment, a transfer of payload data to a destination data store for the computer-assisted development of a control unit and/or of a system controlled or regulated by a control unit. To this end, the destination data store is connected with a computer-assisted development environment that requires the payload data for device and/or system development.

For this purpose, according to an exemplary embodiment of the invention, a data management environment is proposed that includes, on the one hand, the destination data store and, on the other hand, a buffer managed by a buffer controller. In the buffer, the buffer controller provides a data record that includes, firstly, the payload data to be transferred and, secondly, semantic data that are associated with the payload data. Provided in the destination data store, in turn, is a data object with processing-specific object semantics that allow the technical interpretation and processing of the payload data by the development environment.

The object semantics here are processing-specific in the sense that they specify the meaning of the payload data for the processing thereof by the development environment within the framework of the development of the control unit or the controlled device. The object semantics are tailored in this regard to the processing of the payload data by the development environment, and the invention concerns a technique and the associated system architecture for separating the payload data from the technical context determined by the semantic data and appropriately integrating it into the technical context of the development environment determined by the object semantics.

According to an embodiment of the invention, for this purpose the buffer controller instantiates the data object with the payload data on the basis of the semantic data of the data record stored in the buffer by the means that the payload data are placed in the data object as a function of the processing-specific object semantics of the data object in such a manner that the development environment can process the payload data. The method and manner of transmission of the payload data from the data record into the data object is thus a function of both the processing-specific object semantics and the semantic data, which are less specific, or preferably not specific at all, to the processing of the payload data by the development environment.

The buffer can be accorded an interface function here, since it is implemented as a separate memory device that is not a component of either the destination data store or of a source data store from which the payload data originate or in which they were generated. The buffer controller, in turn, manages the buffer and generates the semantic data based on the semantics predefined by a source data store so as to permit mapping of the semantic data to the object semantics required by the development environment.

In this regard, the semantic data represent a “semantic interface” between the technical context of a source data store and that of the destination data store or development environment, and thus allow a semantic/logical decoupling of the technical contexts of the source data stores and destination data stores that are involved in the development of the control unit and/or system. This significantly reduces the scope of the semantic/technical knowledge that a source and/or destination data store requires concerning the data requirements of a corresponding destination and/or source data store within the framework of a distributed, computer-assisted development process. The transfer and provision of data is considerably simplified in this way, since it is now only necessary to map the applicable semantics of a source or destination data store to the semantic interface of the semantic data, and no longer to the sometimes widely differing requirements of various other source or destination data stores.

For example, the payload data can be suitable for and intended for processing by a test environment that is provided by the development environment and that tests or simulates the control unit and/or the controlled or regulated system as part of the development process. In so doing, virtual prototypes of technical devices or systems, or of parts of such devices or systems, are simulated in the development or test environment in the form of software models that model technical characteristics, parameters, states, functions, and interfaces of the device or system to be tested. In this way, it is possible for, e.g., software models of control units, so-called virtual electronic control units (V-ECU), which control other technical devices, for example vehicle engines or vehicle transmissions, to be tested or simulated via methods for control unit modeling or control device architecture modeling, virtual control unit validation, HIL simulation (hardware-in-the-loop), or rapid control prototyping (RCP).

In this context, what is provided by the destination data store as a data object is a test data object with test-specific object semantics that permit the processing of the payload data by the test environment. Accordingly, the buffer controller provides as the data record a test data record with the payload data for the test and associated semantic data, and instantiates the test data object by the means that the payload data are placed in the test data object as a function of the test-specific object semantics in such a manner that the test environment can process the payload data during the test.

In an embodiment, the semantic data also can include metadata that are not only associated with individual data items, but instead are associated with all payload data of a data record. Such metadata can relate to the test to be carried out or a test variant, as well as to an operating mode of the control unit to be tested or of the controlled or regulated system. In connection with a test of a prototype of an engine controller, such metadata can specify, for example, the engine operating mode that is to be tested, e.g., “eco” for a resource-saving operating mode or “sport” for a dynamic, sporty operating mode of the engine. The buffer controller uses the metadata during instantiation in that it selects the test data object to be instantiated on the basis of the metadata or appropriately integrates the metadata into the test data object.

A test data object to be instantiated can also be predefined in the destination data store by a user or operator of the development/test environment. The user can also select multiple test data records in the buffer that concern, e.g., different parameter assignments for different operating modes to be tested so that the buffer controller instantiates the selected test object multiple times with its applicable payload data. Then the test environment can perform the test multiple times with the multiply instantiated test data object, and in this way test or simulate multiple operating modes in the same test scenario or under the same test conditions.

The application example of testing should be understood here as a subdomain of the overarching application example of development. All aspects and features described in connection with the development of software models also apply in this regard to the testing of software models. Thus terms such as “data record,” “data object,” and “processing-specific object semantics” always also mean the corresponding subordinate terms “test data record,” “test data object,” and “test-specific object semantics.”

In an embodiment, the payload data of a data record can include one or more numeric and/or symbolic payload data values, while the semantic data include abstract identifiers that are associated with the individual payload data values. During instantiation, the buffer controller maps the abstract identifiers of the data record to the processing-specific identifiers of the data object and associates the numeric and/or symbolic payload data values with the processing-specific identifiers.

In an embodiment, the abstract identifiers can be constructed from sub-identifiers that allow their construction in the form of a hierarchical structure. Multiple abstract identifiers can thus include identical sub-identifiers as long as any given pair of abstract identifiers always differ from one another with regard to at least one different sub-identifier. In this way, the buffer controller can rationally pre-structure the payload data when generating the data records based on the semantics of the source data store in order to simplify the subsequent instantiation of the data objects. In similar fashion, the processing-specific identifiers of the data objects can also form a hierarchical structure that is composed of sub-identifiers.

Default payload data values which can be predefined in advance, which is to say technical default values for the further processing of the data object by the development environment, are associated with the processing-specific identifiers in a data object. At instantiation, the default payload data values are overwritten with the payload data values of the data record if an abstract identifier of the data record can be mapped to the relevant processing-specific identifier of the data object. If it is not possible to map any abstract identifier of the data record to a processing-specific identifier at instantiation, for example because the data record contains no abstract identifier whatsoever that corresponds to a processing-specific identifier of the data object, the development environment uses the default payload data value of the relevant processing-specific identifier.

On the other hand, a data record can also include abstract identifiers that have no numeric and/or symbolic payload data value, or no meaningful such value, associated therewith. In this case as well, the buffer controller applies the predefined default payload data value of a processing-specific identifier to which the applicable abstract identifier is mapped or could be mapped.

The use of default payload data values in a data object improves data consistency and prevents the processing of payload data by the development environment from failing for the sole reason that the data record is incomplete or the source data store has made incomplete payload data available.

The mapping of abstract identifiers to processing-specific identifiers during the course of instantiation can be accomplished by means of a predefined mapping rule that takes into account, e.g., identity or similarity of the abstract identifiers and of the processing-specific identifiers and/or metadata that the data record includes as semantic data. The similarity of an abstract identifier and a processing-specific identifier can be determined on the basis of, for example, matching sub-identifiers if the abstract identifiers and/or processing-specific identifiers are hierarchically structured.

In addition to the buffer and the destination data store, the data management environment can also include a source data store, or at least be connected via data communication to a source data store. In this case, the buffer controller generates or extracts the data record from a data structure provided by the source data store and saves it in the buffer for later instantiation of one or more data objects.

The data structure provided by the source data store includes, on the one hand, the payload data and, on the other hand, data structure semantics that describe the technical context in which the payload data were generated or are provided in the form of the data structure. The data structure semantics are non-processing-specific with regard to the processing of the payload data by the development environment in the sense that they are not matched to the technical context of the development environment or this context was not taken into account during generation of the data structure. In order to generate the data record, the buffer controller extracts the semantic data from the non-processing-specific data structure semantics, and then constructs the data record from the extracted semantic data and the payload data provided by the data structure.

The data structure semantics can include identifiers that are non-processing-specific in the same sense as the data structure itself. During the generation of the data record, the buffer controller extracts as semantic data from the data structure semantics such non-processing-specific identifiers as can be associated with the processing-specific identifiers of the object semantics of the data object during instantiation. By means of the semantic data and the abstract identifiers thereof, the buffer controller thus mediates between the data structure semantics of the data structure and its non-processing-specific identifiers on the one hand and the object semantics of the data objects to be instantiated and their processing-specific identifiers on the other hand.

Not all non-processing-specific identifiers of the data structure semantics are necessarily adopted during the extraction of the semantic data from the data structure. Instead, such a subset of the sometimes complex data structure semantics as is sufficient to instantiate the data object in such a manner that the development environment can process the payload data using the object semantics can be extracted and used as semantic data. Portions of the data structure semantics that may be useful or indeed necessary for the interpretation of the payload data in the technical context of the source data store but are not necessary for processing of the payload data by the development environment preferably are not incorporated into the semantic data. For example, only the particular non-processing-specific identifiers of the data structure semantics that can be mapped to processing-specific identifiers of a data object at instantiation can be incorporated into the semantic data.

In this way, sufficient basic semantics that represent a thinnest possible or minimal semantic interface between the data structure semantics and the object semantics are extracted from the data structure semantics. The use of these reduced or minimal basic semantics offers the greatest possible flexibility in taking into account the semantic dictates and requirements of different source and destination data stores, because it is possible to dispense with identifiers of data structure semantics and/or object semantics that are specific to the technical context of the applicable source or destination data store but are non-essential for processing of the payload data by the development environment.

Because of the function of the semantic data as a semantic interface, it is neither necessary for technical knowledge about the technical context of the development environment to initially enter into the generation of the data structure, nor is it necessary for the development environment to take into account the technical context of the specific technical environment in which the payload data were generated in order for it to process the payload data. As a result, the combined interface functions of the semantic data and of the buffer permit the logical decoupling and modularization of the source data stores and/or destination data stores employed, or of the underlying devices that generate data or utilize data.

Another factor contributing to the logical decoupling and modularization of the source data stores and/or destination data stores involved is that the buffer can be implemented as a temporary software application of the data processing environment that preferably exists only during the transfer of the payload data from a source data store to the buffer and onward to the destination data store. In this regard, the buffer can be created and terminated as an independent, temporary memory process by the buffer controller as needed. Alternatively, the buffer can also be implemented as a permanent database application of the data management environment, temporally independently of any transfers of payload data, which provides memory areas for the individual payload data transfers that are suitably isolated from one another.

For its part, the data management environment can have a modular structure and includes a database level, a server level, and a client level. While the server level and database level preferably are implemented on a central server of the data management environment, the client level can be implemented by distributed computing devices, each of which implements at least certain functionalities of a source and/or destination data storage module, and which in turn can access the server in a manner according to the invention.

The database level can be composed of a central database that includes a source data memory or source data memory area as well as a destination data memory or destination memory area. The source data memory can be part of a source data storage module and can be configured to store one or more data structures, while the destination data memory, as part of a destination data storage module, is configured to store one or more data objects. To process the payload data, the development environment merely accesses the data objects in the destination data memory, while other portions of the destination data storage modules employed are inaccessible to the development environment.

Within this exemplary modular architecture of the data management environment according to the invention, the buffer is implemented at the client level by a core module that can be implemented on a distributed computing device and has a close data coupling to the server of the data management environment. However, the core module implemented as a client application can be implemented directly on the server of the data management environment.

The buffer controller likewise can be implemented as a client application and includes at least one source application and one destination application. Here, the source application is part of a source data storage module and the destination application is part of a destination data storage module. The source application provides a source data storage module with functions for extracting the data record from the data structure and storing it in the buffer of the core module, while the destination application provides a destination data storage module with suitable functions for instantiating the data object with the payload data of the data record. Thus, a destination data storage module can include not only the destination application of the buffer controller at the client level, but also the destination data memory or destination data memory area at the server level or database level. A source data storage module, in turn, includes the source application of the buffer controller, for example, at the client level, and the source data memory or source data memory area at the server level or database level.

While the destination data storage modules that are employed are integrated into the data management environment, and the buffer controller can easily access the destination data memory in this respect, the source data storage modules that are employed preferably only maintain data communication connections to the server of the data management environment and to the core module. Alternatively, source data storage modules can also be part of the data management environment if the technical circumstances require it. In any event, however, the source data storage modules employed are connected by data communication to the data management environment in such a manner that the source applications thereof can access the source data memory.

In this respect, the client level of the data management environment can be realized through one or more client applications implemented on the corresponding distributed computing devices, which applications jointly implement the buffer controller or its source and destination applications. The buffer is implemented by the core module, which likewise is configured as a client application. A user of the data management environment can thus cause the transfer of the payload data to the client level in such a manner that the server level implements the corresponding database accesses.

The server level can be realized through a server application implemented on the central server that carries out accesses of the database or its source and destination data memories by the buffer controller or its source and destination applications. The core module can provide an individual buffer for each transfer of payload data or for each client application so that the different payload data transfers or different client applications are encapsulated in terms of data, and do not collide with one another.

The modular architecture that is described of the data management environment according to the invention supports the function of the buffer as an interface between the source and destination data storage modules, as well as the function of the data record as a semantic interface between the technical contexts or semantics of the data structures and data objects, in that it permits a logical decoupling of payload data generation on the part of a source data storage module and payload data processing on the part of a destination data storage module or the development environment. The technical/semantic knowledge that a module involved in the development requires about the technical context of other modules is minimized by the modular structure of the data management environment.

In connection with a testing and/or simulation of software models of virtual prototypes of technical devices or systems in a test environment that is provided by the development environment, for example, one or more test management modules and/or variable management modules are used as destination data storage modules. A test management module provides functions, for example, in order to instantiate a data object or test data object in such a manner that the test environment can process the transferred payload data of the test data object for parameterization of the test and/or as variables of the test. A variable management module, however, provides functions within a test scenario in order to instantiate a data object or test data object in such a manner that the test environment can process the transferred payload data of the test data object as variables of the test.

One or more variable management modules or test specification modules, in turn, for example, are employed as source data storage modules. As a source data storage module, a variable management module makes payload data available for a data record, which data the test environment can process as variables of the test by means of a suitable destination data storage module. A test specification module, in turn, makes functions available in order to make payload data available for a data record, which data the test environment can process by means of a suitable destination data storage module for parameterization of a test. In similar fashion, additional modules can be employed that provide particular data management functions with regard to the development or the testing of software models.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a schematic view of the data management environment according to the invention;

FIG. 2 illustrates the steps of the method according to the invention that concern semantic mappings;

FIG. 3 illustrates a schematic view of a data management environment according to the invention;

FIG. 4 illustrates an expanded sequence of steps of the method according to the invention;

FIGS. 5A and 5B illustrate various embodiments of the data management environment together with illustrations of the semantic mappings;

FIGS. 6 to 8 illustrate various embodiments of the data management environment together with illustrations of the semantic mappings;

FIGS. 9A, 9B, and 9C illustrate different variants of semantic data; and

FIG. 10 illustrates an alternative data management environment according to the invention;

### DETAILED DESCRIPTION

The embodiments of the invention described below illustrate possible application scenarios and additional technical aspects of a data management environment and of a method for transferring payload data from a source data storage module to a destination data storage module using a buffer and using particular data records as a semantic interface.

For the purpose of clear and concrete explanation of its manifold advantageous aspects, the invention is described by way of example against the background of a data management environment such as is provided by dSPACE GmbH, Paderborn, Germany, for example, in the form of its SYNECT® data management software for model-based development and for testing and simulation of software models of device prototypes. Nonetheless, the invention is not limited to this platform, but instead is fundamentally suitable for, and intended for, any desired applications of the transfer according to the invention of payload data in connection with a distributed, computer-assisted software development process, regardless of the concrete function, the field of application, or the precise design of the software to be developed. In particular, the invention is not limited to the development and/or testing or simulation of software models for virtual control units (V-ECU) and controlled devices.

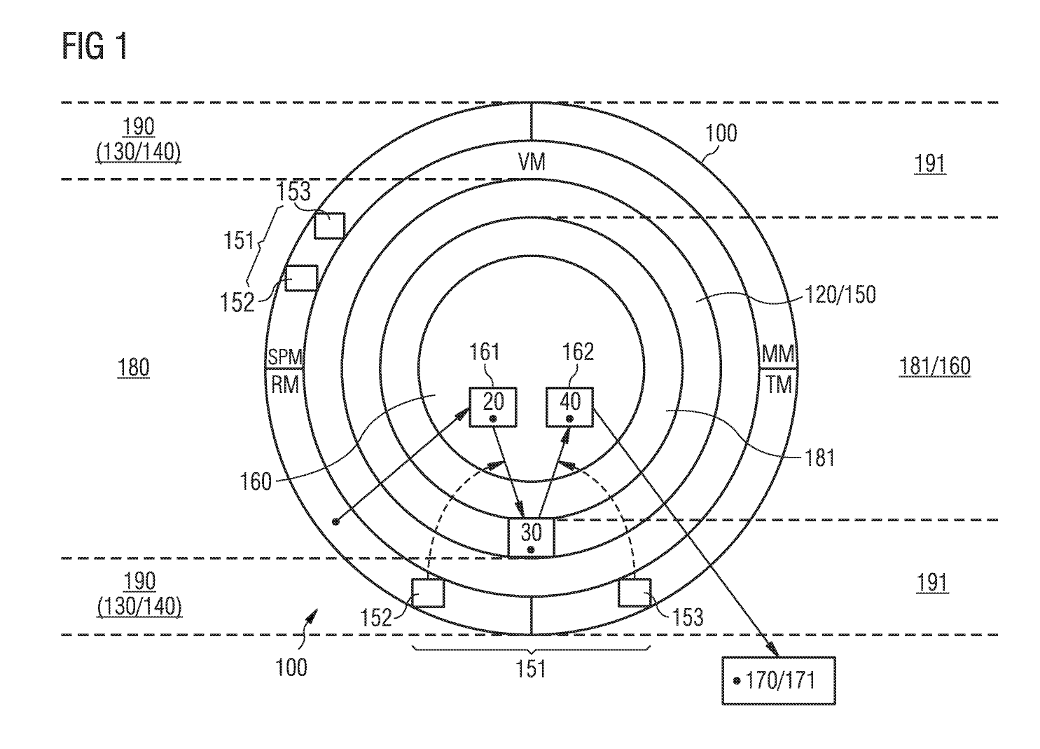

FIG. 1 schematically shows the client/server architecture of a data management environment 100 in the form of a concentric diagram. In this diagram, a data management environment 100 according to the invention (hereinafter referred to as DP environment) is subdivided into a database 160, server applications 181, and client applications 191 (symbolized by the dashed lines leading to the right). Whereas the database 160 and server applications 181 constitute the server level because they are implemented on the central server 180 and provide software server functionalities, the client applications 191 constitute the client level of the DP environment 100 because they are implemented on one or more client computers 190, provide software client functionalities (symbolized by the dashed lines leading to the left), and maintain a suitable data communication connection with the central server 180. The further to the outside a circle in the diagram is located, the greater its structural distance and data abstraction from the database 160 as the central data memory of the DP environment 100.

A special position is occupied here by the core module 120, which is indeed implemented on the central server 180 as shown in FIG. 1 because it provides, together with the buffer 150, an interface resource according to the invention for all source and destination data storage modules 130, 140, but despite this fact is implemented there in the form of a client application 191, since it does not function as a server application 181 either structurally or functionally. Alternatively, however, the core module 120 can also be implemented on a selected client computer 190.

A development environment 170 or a test environment 171 provided thereby accesses the DP environment 100 in order to obtain payload data 10 that are required in connection with the development and/or testing of virtual prototypes or software models of technical devices or systems, as for example control units or controlled or regulated systems.

The client applications 191 represent primarily source data storage modules 130 and destination data storage modules 140 in the meaning of the invention (hereinafter referred to as source modules or destination modules). In addition, other client applications 191 are also possible that perform tasks that are not connected, or are only partially connected, with the invention.

The client level of the DP environment 100 is composed of the two outer circles of the diagram in FIG. 1. In the outer of the two circles, various source and destination modules 130, 140 are provided, for example a test management module TM, a model management module MM, a variable management module SPM (Signal Parameter Management), and a specification module RM (Requirements Management).

Provided on the inner of the two circles is a variant management module VM that allows variant or configuration management of software models in connection with the development and testing of software models. In this function, the VM module interacts with other source and destination modules 130, 140 and can also function as a source and/or destination module 130, 140 itself.

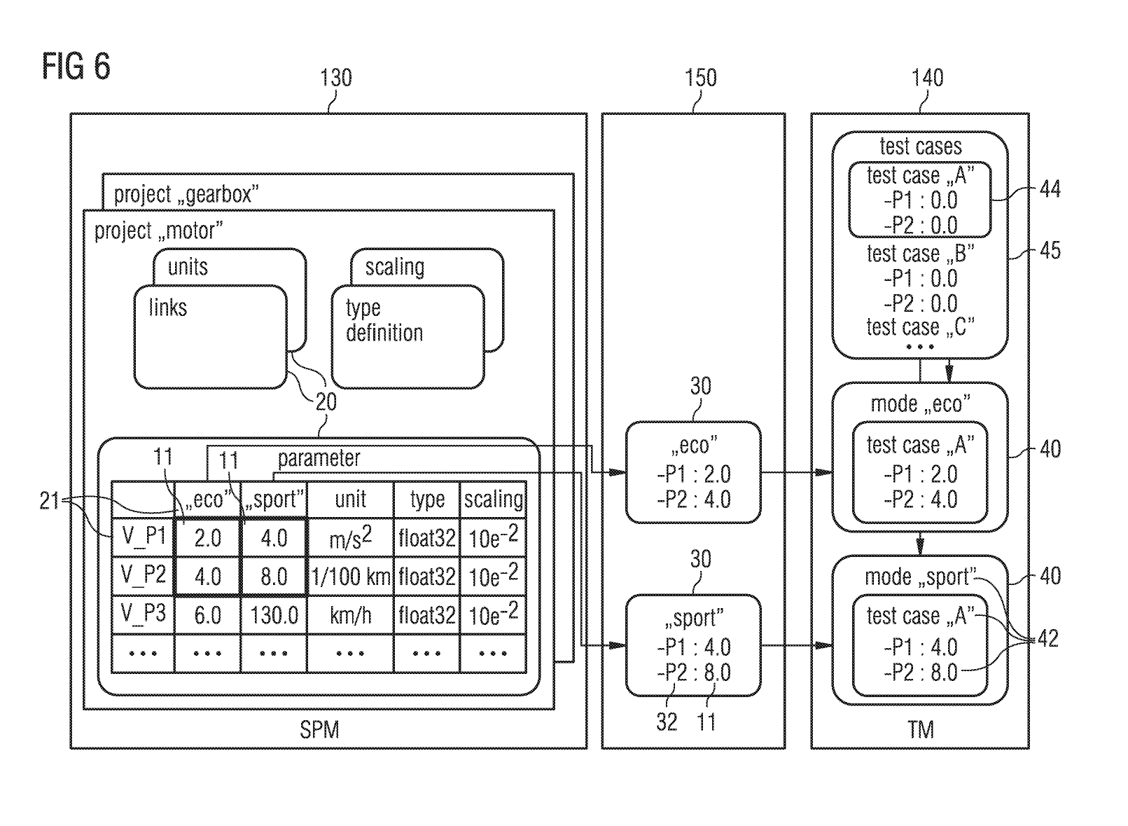

While the RM module generally functions as a source module 130 (see FIG. 7), and the TM module generally functions as a destination module 140 (see FIG. 5), the SPM module is routinely used as both a source module 130 and a destination module 140 (see FIGS. 5 and 8).

In the context of testing of software models, the TM module supports, among other things, the management, planning, monitoring, and evaluation of test cases, test scenarios, and test runs, for example in connection with an HIL simulation (hardware-in-the-loop) by the test environment 171. The SPM module manages the signals and signal values, parameters and parameter sets, as well as variables and variable assignments of the entire DP environment 100 and for other source/destination modules 130, 140 and for the test environment 171. It supports commonly used file formats and data structures, and can be connected to other technical devices and modules (not shown) that feed payload data 10 into the DP environment 100 through the SPM module. The RM module, in turn, makes available to the DP environment 100 data, parameters, and test specifications that are needed for carrying out tests and simulations, in particular test cases and test scenarios that the test environment 171 is to run using the payload data 10. Finally, the MM module manages software models together with their virtual interfaces, parameters, and associated files, documents, and specifications. Through technical interfaces to other technical devices and modules (not shown) that generate or process payload data 10, it makes possible the distributed development, processing, testing, and simulation of software models.

The server level of the DP environment 100 is composed of the two inner circles of the diagram in FIG. 1. The innermost circle represents the database 160 with the source data memory 161 and the destination data memory 162 as labeled memory areas (hereinafter referred to as source memory and destination memory). Access to the memory areas 161, 162 on the server side by modules 130, 140 on the client side is achieved through one or more server applications 181. Such accesses (represented by dashed lines in FIG. 1) are undertaken in particular by source applications 152 and destination applications 153, which are each a component of a source module 130 or destination module 140 while also being a component of a buffer controller 151. The buffer controller 151 manages the buffer 150, in particular undertakes the semantic mappings and operations according to the invention, and coordinates or accomplishes transfers of the payload data 10.

In addition, it is also possible to provide at the server level a programming interface (API) that provides external devices with standardized access to server-side functions and to functions of the core module 120. By means of the API, it is possible to feed data into the DP environment 100 while bypassing the source modules 130, for example from commonly available spreadsheet programs or proprietary data management tools, such as Matlab®/Simulink® or the like, that are not part of the DP environment 100.

The modular structure of the DP environment 100, which is described once more from a different perspective in conjunction with FIG. 5, supports the interface function of the buffer 150 and the buffer controller 151, and in this way allows the semantic decoupling of the data processing by the development and testing environment 170/171 from the data generation or the applicable data source.

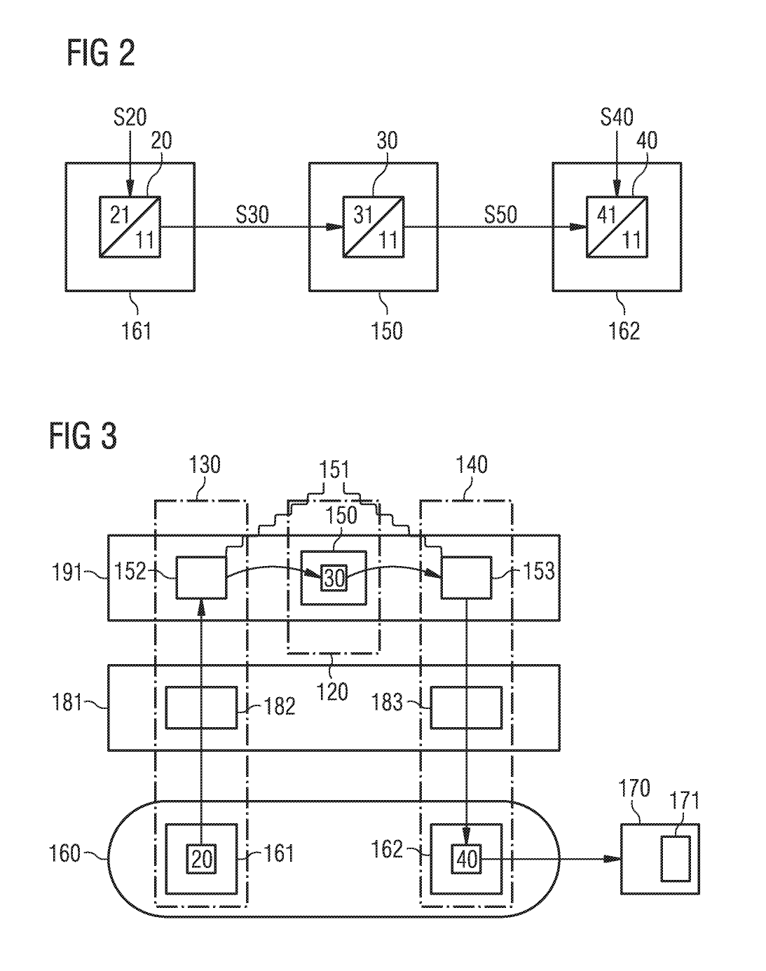

The payload data 10 and the processing routes thereof through the DP environment 100 are indicated by bold-faced dots in FIG. 1. This is illustrated further with the aid of the sequence of steps from FIG. 2. Like FIG. 1, FIG. 2 also shows the source memory 161 with a data structure 20 located therein, the buffer 150 with a data record 30 located therein, and the destination memory 162 with a data object 40 located therein. The data structure includes the payload data 10 to be transferred as well as data structure semantics 21 (hereinafter referred to as structure semantics), the data record 30 includes the same payload data 10 as well as semantic data 31, and the data object 40, in turn, includes the same payload data 10 as well as object semantics 41.

The structure semantics 21 convey the meaning of the payload data 10, which is to say their semantics, in the technical context of the source module 140 or the particular device that generates the payload data 10 and transfers them to the source module 130, which stores the data structure in the source memory 161 in step S20. Analogously, the object semantics 41 convey the meaning of the payload data 10, which is to say their semantics, in the technical context of the development/testing environment 170/171. The semantic data 31, in turn, represent basic semantics that are reduced as compared to the more complex structure semantics 31 and/or the more complex object semantics 41, and in this regard serve as a “semantic interface” between the structure semantics 31 and the object semantics 41.

In step S30, the buffer controller 151 (or the source application 152) extracts the data record 30 from the data structure 20 by the means that it maps the structure semantics 21 to the semantic data 31, which is to say the reduced basic semantics, and associates the payload data 10 accordingly. The data record 30 is stored in the buffer 150.

In step S50, the buffer controller 151, or the destination application 153, instantiates the data object 40 that was provided in the destination memory 162 by the destination module 140 in step S40, by the means that it maps the semantic data 31, which is to say the reduced basic semantics, to the object semantics 41 and associates the payload data 10 accordingly. The instantiated data object 40 is ultimately read out of the destination memory 162 by the development/testing environment 170/171, and its payload data 10 are used for further development or testing of the software model.

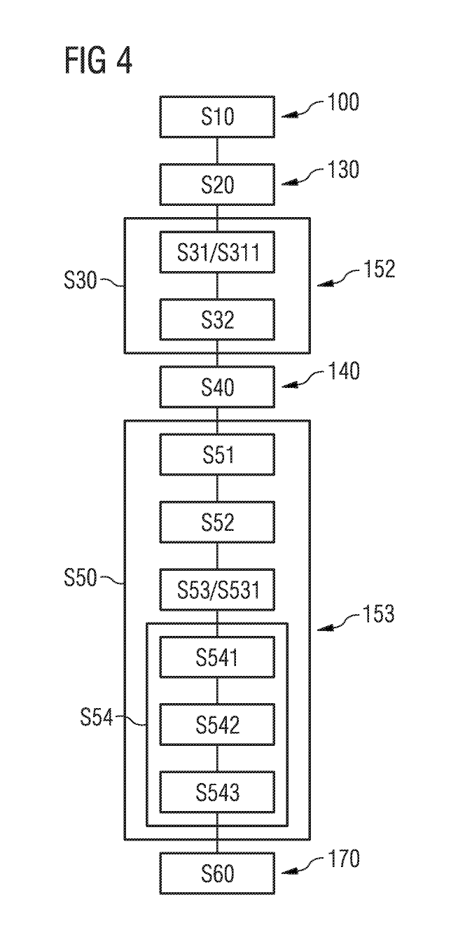

The alternative structure of the DP environment 100 in FIG. 3 again shows the three levels of the DP environment 100, namely the database 160, the level of the server applications 181, and the level of the client applications 191. FIG. 3 illustrates, in particular, the structure of the source and destination modules 130, 140, include portions at the client level, namely the source and destination applications 152, 153, portions at the server level, namely the source and destination module servers 182, 183, and portions at the database level, namely the source and destination memories 161, 162. In this design, the source and destination module servers 182, 183 implement, on the server side, the accesses and queries to the source and destination memories 161, 162 originating from the source and destination applications 152, 153.

In an exemplary embodiment of the DP environment 100 from FIG. 3, the DP environment 100 includes the core module 120 with the buffer 150 and one or more destination modules 140, but no source modules 130. In other words, the source module 130 is not integrated into the distributed hardware and software structure of the DP environment 100 in this variant. In this context, there are a great many possible embodiments, in particular with regard to implementation of the source application 152 and the source memory 161. Thus, the separate source module 130 may possess, for example, only one memory area corresponding to the source memory 161 and additional control structures, while the function of the source application 152 is implemented on the core module 120 or on the central server 180. In this embodiment, the entire buffer controller 151, which is to say the functions of both the source application 152 and the destination application 153, can be implemented on the core module 120 or the central server 180 with the consequence that the function of the destination application 153 is not implemented by the destination module 140. Alternatively, it is also possible for only the function of the source application 152 to be taken on by the core module 120 or the central server 180, while the function of the destination application 153 continues to be part of the destination module 140. In another design of this variant embodiment, the function of the source memory 161 can continue to be provided by the database 160 while the separate source module 130 includes the source application 152.

The buffer controller 151 is implemented at the client level, since both of its essential components, namely the source and destination applications 152, 153, are provided by the source and destination modules 130, 140 which interact but are separate physically and in terms of software. As a result, the DP environment 100 does not necessarily have only one buffer controller 151, but instead every pair of interacting source and destination modules 130, 140 can form an individual buffer controller 151, for example as communicating, temporary processes on the corresponding client computers 190, that accomplishes the individual transfers of payload data 10 between the relevant modules and the corresponding semantic mappings and operations. Such a situation is shown in FIG. 1, for example, where in addition to the buffer controller 151 (152, 153) formed by the TM module and the RM module, another buffer controller 151 (152, 153) is formed by the SPM module.

The buffer 150 is established on the central server 180 by the client-side core module 120. In this regard, the buffer 150 can indeed be integrated into the database 160, but can also be realized separately from the database 160 as an independent database application. Just as it is possible for there to be multiple buffer controllers 151 in the form of temporary processes, the core module 120 can associate a separate buffer 150 with each buffer controller 151, e.g., once again as a temporary process, so that the various payload data transfers are encapsulated in terms of data and do not collide. The data records 30 in a temporary buffer 150 are local and volatile in this regard, so that different modules 130, 140 can access the same data records 30 without access conflicts.

The extraction of the data record 30 from the data structure 20 by the source application 152 (step S30) thus takes place entirely within the source module 130—with the exception of the storage of the data record 30 in the destination memory 150. Likewise, the instantiation of the data object 40 on the basis of the data record 30 by the destination application 153 (step S50) takes place entirely within the destination module 140—with the exception of the readout of the data record 30 from the destination memory 150.

Since the buffer controller 151 is implemented entirely at the client level, its source and destination applications 152, 153 are accessible to the users of the DP environment 100. In this respect the users have the option of defining, through the source and destination applications 152, 153, individual rules for semantic mapping of the structure semantics 21 to the basic semantics of the semantic data 31 (step S40) or of the basic semantics of the semantic data 31 to the object semantics 41. These rules pertain to the derivation of the specific identifiers 42 of the data object 40 from the abstract identifiers 32 of the data record 30 and the derivation of the abstract identifiers 32 from the nonspecific identifiers 22 of the data structure 20.

In this way, matching payload data values 11 present in the source and destination modules 130, 140 can be used differently, in a way that is user-specific and tailored to the requirements of the particular application. As a result, conflicts with regard to data access and data consistency in the buffer 150 can be avoided, because the buffer 150 is local with respect to each individual payload data transfer and its data records 30 are encapsulated with respect to other data records 30 that are created in connection with parallel payload data transfers. For this reason, it is easily possible according to the invention to use matching identifiers 32, 22, 42. Another advantage is that the data volume in the buffer 150 is minimized, which simplifies the semantic mappings and operations of steps S30 and S50.

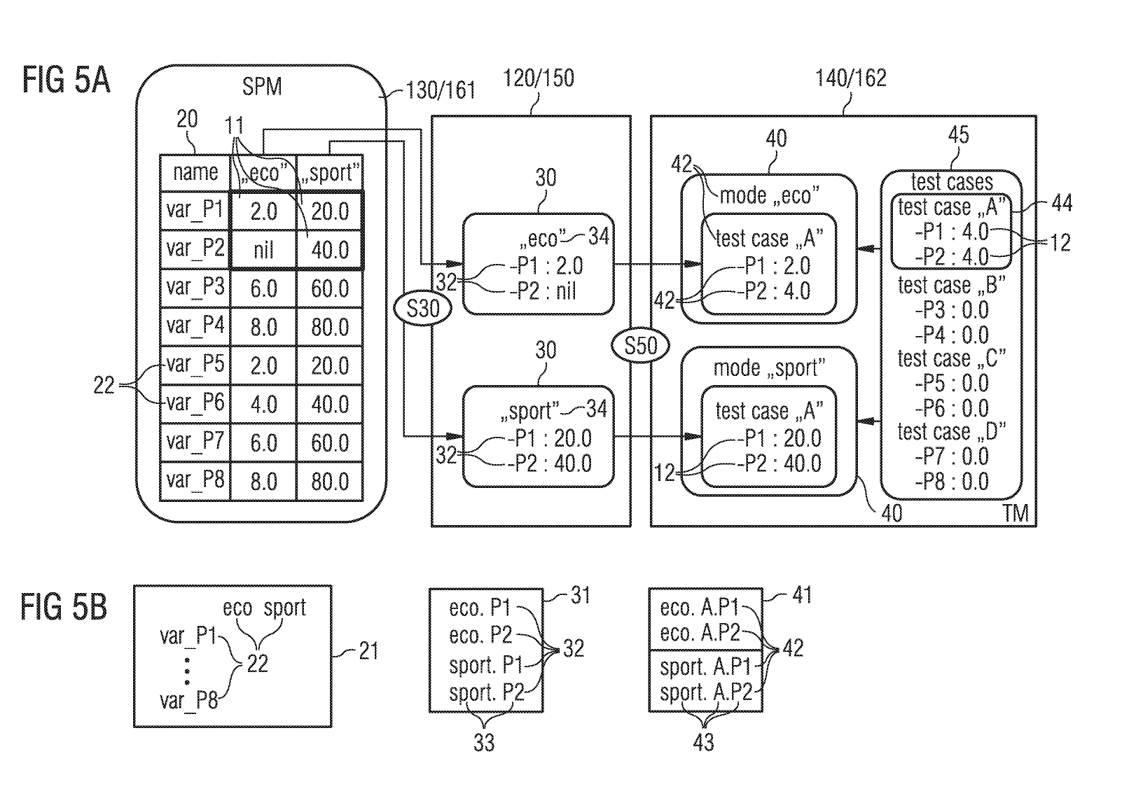

FIG. 4 shows a sequence of steps of the method according to the invention that is expanded as compared to FIG. 2. This is explained below in conjunction with FIG. 5, which illustrates in greater detail the semantic mappings and operations, in particular, in connection with the extraction step S30 and the instantiation step S50. In addition, the particular units of the DP environment 100 that execute the step in question are noted and marked with an arrow. Shown in FIG. 5(a), in contrast, are the modules 130, 120, 140 and memory units 161, 150, 162 of the DP environment 100 involved in the steps S30 and S50, as well as the data managed thereby, namely the data structures 20, data records 30, and data objects 40. Complementary thereto, FIG. 5(b) illustrates the corresponding semantics, namely the structure semantics 21, the semantic data 31, and the object semantics 41.

The method from FIG. 4 starts in step S10 with the DP environment 100 providing the buffer 150 and at least one destination module 140 in the form explained in conjunction with FIGS. 1 and 3. The further steps S20 to S60 in FIG. 4 correspond functionally to the steps S20 to S60 in FIG. 2, whereas in step S70 the test environment 171 finally reads the data object 40 with the payload data values 11 out from the destination memory 163 and uses these within the framework of testing or simulation of a software model.

The step S20, in which the data structure 20 is made available in the source memory 161, for instance by the source module 130 itself or by another module or the particular device that generated the payload data 10, is followed by the steps S31 or S311 and S32, which together form the extraction step S30 according to FIG. 2.

Functioning as the source module 130 in FIG. 5 is an SPM module for managing variable values that supplies lists or tables with variable assignments as payload data values 11 that the TM destination module 140 can use to populate with data test cases that are to be run by the test environment 171. The payload data values 11 are provided by the SPM module 130 as a relational data structure 20 in the form of a two-dimensional table. The relational data structure 20 comprises, in the horizontal direction, eight entries having one identifier 22 (var_P1, var_P2, . . . , var_P8) apiece and two payload data values 11 apiece, each of which is associated either with the attribute “eco” or the attribute “sport”. The identifier var_P2 under the attribute “eco” is not occupied by a valid payload data value 11, which is to say that the corresponding memory location of the source memory 152 is empty or is occupied by a corresponding symbol, e.g., “nil,” “void,” or the like.

The payload data values 11 may be alphanumeric, symbolic, or otherwise suitable values or strings that can be processed by the test environment 171. In particular, the payload data values 11 can also represent complex payload data values 11, for example pairs of values or value vectors including signal, parameter, or stimulus data values and corresponding reference data values.

The relational table structure with the identifiers 22 and the attributes constitutes the structure semantics 21 of the data structure 20 here. The identifiers 22 and the structure semantics 21 as a whole are nonspecific with respect to the processing of the payload data 10 by the test environment 171, since the data structure 20 is generated independently of the semantic/technical context of the test environment 171, and the object semantics 41 expected by the test environment are not taken into account. Conversely, however, it is also true that the identifiers 42 and the entire object semantics 41 are independent of the semantic/technical context of the creation of the payload data 10.

Thus, whereas the structure semantics 21 and their identifiers 22 are nonspecific for the processing of the payload data 10 (which is to say non-processing-specific or non-test-specific), the object semantics 41 and their identifiers 42 are specific for this processing (which is to say processing-specific or test-specific). The semantic decoupling with regard to the processing of the payload data 10 by the test environment 171 is expressed by the term pair “(processing-)specific/non-(processing-)specific”. This semantic decoupling is bridged by the semantic data 31 and the abstract identifiers 32 thereof, functioning as semantic interface. It is for this reason alone that the structure semantics 21 can be made nonspecific with respect to the object semantics 41.

In step S31, the source application 152 extracts the semantic data 31 from the structure semantics 21 and forms, in step S32, the data record 30 from the extracted semantic data 31 and the correspondingly associated payload data values 11. The payload data value “nil” is incorporated unchanged in the data record 30 from the data structure 20 here.

In the example from FIG. 5, the source application 152 does not extract all the payload data values 11 provided by the relational data structure 20, but instead only the payload data values 11 that are linked to the nonspecific identifiers 22 “var_P1” and “var_P2,” because the source application 152, as part of the buffer controller 151, knows that the data object 40 to be instantiated by the destination application 153 in the TM destination module 140 concerns a test case A that has only two input variables.

To this end, in step S311 semantic data 31 in the form of reduced basic semantics are derived from the complex structure semantics 21, by the means that exactly the particular abstract identifiers 32 that refer to the required payload data values 11 are abstracted from the nonspecific identifiers 22 of the data structure 20 for the semantic data 31. In this process, the generic portions of the nonspecific identifiers 22 are incorporated as abstract identifiers 32, while the character string “var_” is discarded, since it has no meaning in the context of the TM destination module 140. In the context of the SPM source mode 130, the attributes “eco” and “sport” designate different operating modes of a software model of an engine controller or of an engine. Within the framework of the structure semantics 21, they constitute nonspecific identifiers 22.

The source application 152 reduces the structure semantics 21 in this respect to the abstract identifiers 32 “P1,” “P2”, and forms two separate data records 30 in the buffer 150, since the two variable assignments pertain to different operating modes of the same test case in the context of the TM destination module 140. The attributes “eco” and “sport” of the structure semantics 21 are placed in the data records 30 as metadata 34, which give higher-level information on the applicable payload data values 11 of the data record 30 in question. The corresponding semantic representation in FIG. 5(b) shows, however, that the source application 152 has extracted the composite, abstract identifiers 32 “eco.P1,” “eco. P2,” “sport.P1,” and “sport. P2,” from the relational structure semantics 21. The sub-identifiers 33 “eco,” “sport,” “P1,” and “P2” thus form a hierarchical structure for constructing the semantic data 31.

In step S40, the TM destination module 140 generates in the destination memory 162 a data object 40 as the starting point of a parameterization with payload data values 11 in the subsequent instantiation step S50. The data object 30 is generated on the basis of a library 45 with templates 44 for various test cases and test scenarios by the means that it is created starting from the particular test case (here, “test case A”) that the test environment 171 is to run. Any standard or default payload values 12 provided by the applicable template are incorporated in the generated data object 30, where they are if necessary overwritten with payload data values 11 from the data record 30 during instantiation. The object semantics 41 of the generated data object 40 accordingly include the identifiers 42 “P1” and “P2” as variables of the test case, along with an item of metainformation that designates the selected test case.

The step S40 is followed by the steps S51, S52, S53/S531, and S54, which in turn comprises the steps S541, S542, and S543. All of these steps together form the instantiation step S50 from FIG. 2. Accordingly, a user of the DP environment, for instance a development engineer or test engineer, selects one or more data records 30 in the buffer (step S51) and a data object 40 in the destination memory 162 (step S52). In the present example, he can select the two data records 30 and the single data object 40 that resulted from the template 44 of the test case A. The data object 40 is then instantiated separately with each data record 30, with the result that two data objects 40 are produced that incorporate the payload data values 11 of the two data records 30.

In step S53, the destination application 153 maps the abstract identifiers 32 of the two data records 30, or the relevant sub-identifiers 33, to the specific identifiers 43 of the data object 40. During this process, it is determined within the framework of an identity test in step S531 that the abstract identifiers 32 (or sub-identifiers 33) “P1” and “P2” of the data records 30 correspond to the specific identifiers 42 (or sub-identifiers 43) “P1” and “P2” of the data object 40. Furthermore, it is determined in step S531 that, on the part of the data records 30, the metadata 34 (or sub-identifiers 33) “eco” and “sport” are present, and on the part of the data objects 40, the metadata (or sub-identifiers 43) “test case A” or “A” is present. Accordingly, the identifiers 32, 42 “P1” and “P2” are mapped to one another, and the metadata 34 are linked to one another combinatorially and used as sub-identifiers 43 of the object semantics 41.

In this context, standardized identifiers or systemwide or industry-specific standard names can also be employed, which are predefined by means of the template 44, for example. The standardized identifiers “P1” and “P2” of the template 44 are incorporated in the data object 40 as specific identifiers 42 and correctly instantiated, even when the abstract identifiers 32 of the data object 30 differ, for example “V1” and “V2”, “PA” and “PB”, or “X” and “Y”, as long as they can be distinguished and identified on the basis of the semantic data 31.

The object semantics 41 shown in FIG. 5(b) are produced in the manner described with the sub-identifiers 43 “eco”, “A”, “P1”, “P2”, and the hierarchical identifiers 42 that result therefrom, “eco.A.P1”, “eco.A.P2”, “sport.A.P1”, and “sport.A.P2”. Accordingly, the data object 40 generated from the template 44 is instantiated twice in step S541, namely once with the payload data values 11 for the operating mode “eco” (2.0, nil) and once with the payload data values 11 for the operating mode “sport” (20.0, 40.0). The test environment 171 can then perform the test case A once with the data object 40 initialized to the operating mode “eco” and once with the data object 40 initialized to the operating mode “sport”.

When the payload data values 11 are placed in the data object 40, the default payload data values 12 from the template 44 (4.0, 4.0) are overwritten (step S542) if payload data values 11 to be appropriately associated are present in the applicable data record 30. If no such payload data values 11 are present, the applicable default payload data values 12 remain in place, or are adopted from the template 44 (step S543). In this regard, the data object 40 intended for the test case A in the operating mode “eco” passes the default payload data value 12 (4.0) on to the test environment 171.

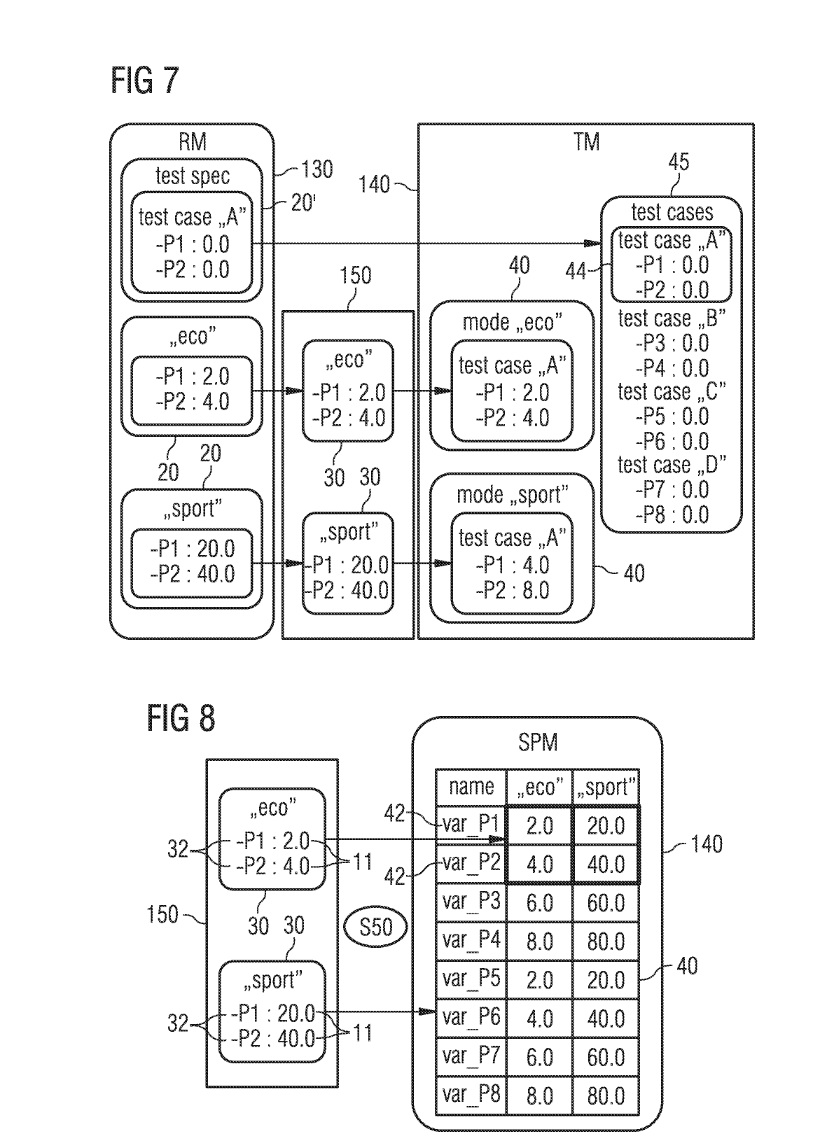

FIG. 6 shows a variant of the DP environment 100 from FIG. 5 in which the SPM source module 130 is developed in further detail, and the buffer 150 and the TM destination module 140 correspond to those from FIG. 5. The relational data structure 20 includes yet more table columns that relate to physical units (unit), data types (type), and scaling (scale). These are not incorporated during extraction of the data records 30 in step S30, because they are not required for instantiation of the data object 40 based on the template 44, even though they are useful in the technical context of variable management of the SPM module. The instantiation step S50 corresponds to the one in FIG. 5.

Moreover, the data structure 20 is only one of many within the test project “motor”. There are also additional relational data structures that relate to other technical aspects, for example parameters, units, scaling, links, for example to specifications, documentation, or additional data. Furthermore, the SPM module holds still more project data available, for example for a test project “gearbox” for testing software models for vehicle transmissions.

FIG. 7 shows another variant of the DP environment 100 in which an RM module that provides signal values, parameters, and the like as payload data values 11 serves as the source module 130 so that the TM destination module 140 can again parameterize test cases. The test cases parameterized in this way in the TM destination module 140 can be managed there and reused so that different test cases and test scenarios can be performed with different parameter values and compared.

In accordance with its specification function for test cases, the RM source module 130 has data structures 20 with associations between test parameters as payload data values 11 and nonspecific identifiers 22 that are already associated with certain operating modes, such as “eco” and “sport”, for example. The extraction step S30 includes in this regard of importing the already suitably pre-structured data structures 20 into the buffer 150 as data records 30, because the source application 152 knows that the data object 40 to be instantiated by the destination application 153 in the TM destination module 140 relates to the test case A, with which different operating modes are to be tested out.

In addition, the RM source module 130 also makes available a data structure 20′ that provides a specification of the test case A with two input parameters P1 and P2. The data structure 20′ is transmitted by the buffer controller (or the core module 120), bypassing the buffer 150, directly to the library 45 as a template 44, where it is used for generating the data object 40 in step S40. The data structure 20′ from FIG. 7 represents a logical or nonspecific specification of a test case without default payload data values 12 that is not yet tailored to the specific test case, while the template 44 has default payload data values 12 that the TM destination module 140 can associate with the applicable identifiers 42 on account of its knowledge about the specific test by the test environment 171. This special manner of treating the data structure 20′ is carried out on the basis of the metadatum “spec,” which specifies that what is involved here is not a data structure 20 with parameter values, but instead a test specification. The instantiation step S50 corresponds to the one in FIG. 5.

In both cases, namely the transfer of the parameters of the data structures 20 and the transfer of the test specification of the data structure 20′, only knowledge about the semantics of the data records 30 or templates 44 is needed, but not about the concrete object semantics 41 of the data objects 40 used by the test environment 171. In this regard, the semantic interface function also arises from the direct transfer of the data record 20′ to the destination module 140, since the templates 44 of the library 45 are abstracted in a manner similar to the data records 30 with respect to the specific object semantics 41.

In addition, it is also possible to assemble other data for test preparation with the mechanism shown in FIG. 7, for example paths to software models, recordings of measured values, or the specification of software versions that must be available on the test environment 171 for the execution of a test.

FIG. 8 shows a variant of the DP environment 100 in which the SPM module, as the destination module 140, uses the payload data 10 of the data records 30 in the buffer 150 to carry out variable assignments in the data object 40. Although the SPM module does serve as the variable manager for the development/test process, it does not generate the payload data values 11 that it associates with the variables, but instead its role is to import them from files or external devices that generate payload data. FIG. 8 illustrates that this importation can be implemented within the DP environment 100 via the buffer 150 and the buffer controller 151. The RM module from FIG. 7, which transfers data structures 20 with parameter sets for a test to the SPM module 140, can serve as the source module, for example. In a departure from the process shown in FIG. 7, an RM source module 130 can also transfer data structures 20′ with specifications (spec) of test cases to an SPM destination module 140 or a TM destination module 140 via the buffer 150.

In the instantiation step S50 from FIG. 8, the payload data values 11 of the data records 30 are integrated into the relational data object 40 by the means that the abstract identifiers 32 “P1” and “P2” of the semantic data 31 are mapped (step S53) to the specific identifiers 42 “var_P1” and “var_P2” of the object semantics 41, and the relevant payload data values 11 are associated accordingly (step S54).

In all embodiments and variant embodiments from FIGS. 5 to 8, additional functions may be provided in the various source and destination modules 130, 140 that can, if applicable, be based on the semantic interface of the semantic data 31 or of the basic semantics provided thereby, independent of the source or destination application 152, 153. For example, a TM destination module 140 can possess a function that searches for variable assignments or parameters in the data records 30 of the buffer 150.

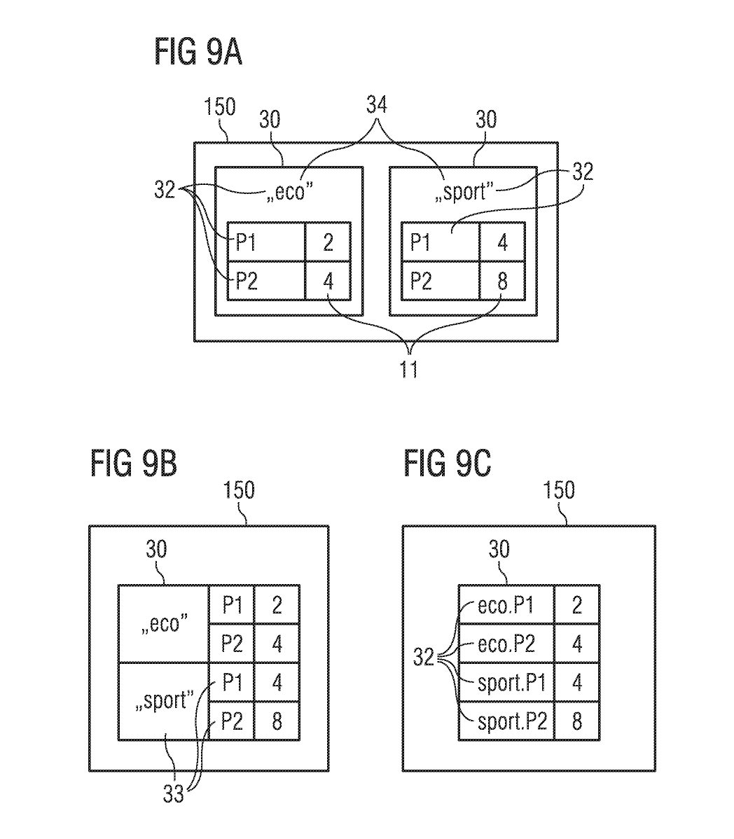

FIG. 9 illustrates different variants of data records 30 and semantic data 31 for the case of equivalent semantic structure and the same payload data values 11. FIG. 9(a) shows two separate data records 30 in the buffer 150 for the operating modes “eco” and “sport,” each of which includes two pairs having abstract identifiers 31 and payload data values 11. The operating modes are coded in the form of metadata 34 here. FIGS. 9(b) and 9(c) show alternative representations of the same semantic structure, in which the metadata 34 are integrated into hierarchical identifiers 32 as sub-identifiers 33. In this regard, FIG. 9(b) shows the hierarchical identifier structure in the form of a tree, while the hierarchical identifiers 32 in FIG. 9(c) are resolved by the means that the relevant sub-identifiers 33 are concatenated appropriately.

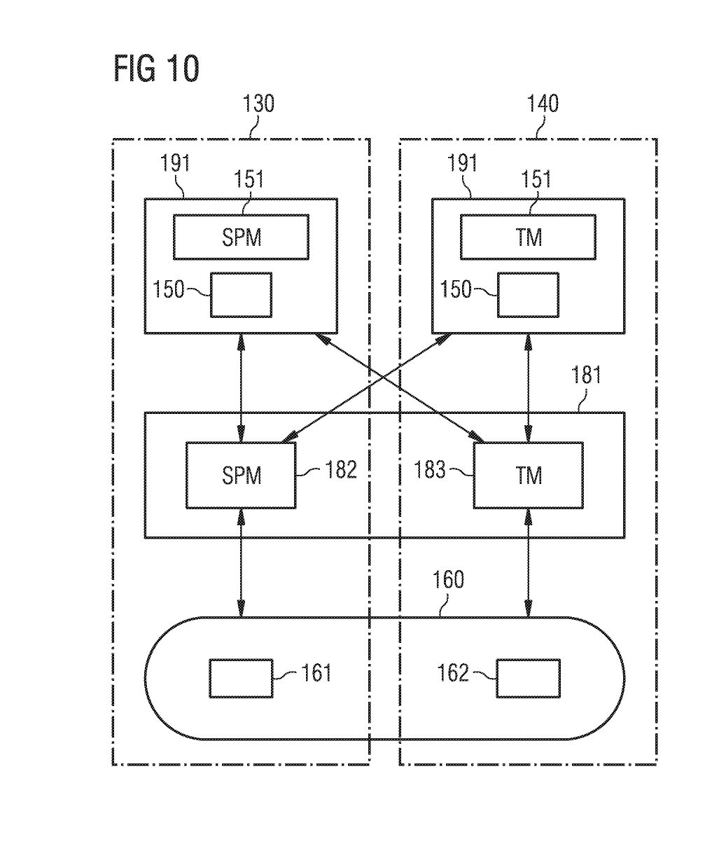

FIG. 10 shows another alternative structure of a DP environment 100. The difference in the arrangement in FIG. 10 from the one in FIG. 3 resides in the client-side use of multiple individual buffers 150 and buffer controllers 151 for different payload data transfers. The data records 30 in a buffer 150 are isolated in terms of data in this way from the data records 30 that are created in the course of other payload data transfers. The multiple buffers 150 can also be implemented as isolated, temporary memory processes of the relevant source or destination module 130, 140. Alternatively, the application-related encapsulation of data records 30 already discussed can be achieved by the means that data records 30 belonging to a payload data transfer are stored in an isolated container of a central buffer 150 as in FIG. 3.

The modules shown in FIG. 10, namely the SPM source module 130 and the TM destination module 140, each include client applications 191 and server applications 181, as has already been discussed in conjunction with FIG. 3. The relevant client applications 191 here primarily include complete, individual buffer controllers 151 that combine the functionalities of the source and destination applications 152, 153. Since the buffers 150 according to the architecture from FIG. 10 are implemented directly in the relevant source or destination module 130, 140, the client applications 191 of a module 130, 140 can also communicate with the server application 181 (182, 183) of the relevant other module 140, 130. Thus, for example, the client application 191 of the SPM source module 130 can access its own buffer 150, carry out the required semantic mappings and operations there, and instantiate a data object 40 that is present in the destination memory 162 of the TM destination module 140 directly via the server application 183 of the TM destination module 140.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for transfer of payload data from a buffer to a destination data store, the payload data adapted for processing during development, using a computer-assisted development environment connected with the destination data store of a control unit and/or of a system controlled or regulated by a control unit, the method comprising:
providing a data management environment of the buffer and the destination data store;
providing in the buffer by a buffer controller, a data record having payload data and semantic data, which are associated with the payload data;
providing in the destination data store of a data object having processing-specific object semantics that allow the processing of the payload data by the development environment; and
instantiating by the buffer controller of the data object with the payload data on the basis of the semantic data,
wherein the payload data are placed in the data object as a function of the processing-specific object semantics of the data object such that the development environment is adapted to process the payload data during the development.

2. The method according to claim 1, wherein the payload data are transferred that are adapted for processing by a test environment that is provided by the development environment during a test of the control unit and/or of the controlled or regulated system, wherein a test data object with test-specific object semantics that permit the processing of the payload data by the test environment is provided as a data object, and wherein the buffer controller:
provides, as the data record, a test data record having the payload data for the test and having the semantic data; and
instantiates the test data object,
wherein the payload data are placed in the test data object as a function of the test-specific object semantics such that the test environment processes the payload data during the test.

3. The method according to claim 2, wherein the test data record includes, as semantic data, metadata that concern the test and/or a test variant and/or an operating mode of the control unit to be tested or of the controlled or regulated system, and wherein the buffer controller uses the metadata for instantiation of the test data object.

4. The method according to claim 2, wherein a user selects a test data object in the destination data store, and the selected test data object is instantiated with the payload data of the test data record and/or the user selects multiple test data records in the buffer and the selected test data object is instantiated multiple times with the applicable payload data such that the test environment performs the test multiple times with the multiply instantiated test data object.

5. The method according to claim 1, wherein the data record includes numeric and/or symbolic payload data values as payload data and the abstract identifiers that are associated with the numeric and/or symbolic payload data values as semantic data, wherein the processing-specific object semantics of the data object include processing-specific identifiers, wherein the buffer controller during instantiation, maps the abstract identifiers to the processing-specific identifiers and associates the numeric and/or symbolic payload data values with the processing-specific identifiers, and wherein the abstract identifiers are constructed of sub-identifiers that constitute a hierarchical data structure for a construction of the abstract identifiers.

6. The method according to claim 5, wherein predefined default payload data values are associated with the processing-specific identifiers in the data object, and the semantic data includes such abstract identifiers and have no numeric and/or symbolic payload data values associated therewith, wherein the buffer controller during instantiation:
applies the predefined default payload data values when the processing-specific identifiers to which such abstract identifiers are mapped and which have no numeric and/or symbolic payload data values associated therewith in the data record; and
overwrites the predefined default payload data values with the relevant numeric and/or symbolic payload data values when the processing-specific identifiers to which such abstract identifiers are mapped and which do have numeric and/or symbolic payload data values associated therewith in the data record.

7. The method according to claim 1, wherein the buffer controller, during instantiation, maps the abstract identifiers to the processing-specific identifiers in accordance with a predefined mapping rule, wherein the mapping rule considers the identity or similarity of the abstract identifiers and the processing-specific identifiers and/or metadata that the data record includes as semantic data.

8. The method according to claim 1, wherein the buffer controller extracts the data record from a data structure stored in a source data store and stores it in the buffer in that the semantic data are extracted from non-processing-specific data structure semantics of the data structure, and wherein the data record is constructed from the semantic data and the payload data designated by the semantic data.

9. The method according to claim 8, wherein the non-processing-specific data structure semantics include non-processing-specific identifiers and the buffer controller extracts the semantic data from the non-processing-specific data structure semantics such that such non-processing-specific identifiers are extracted as semantic data from the data structure semantics as are mappable to processing-specific identifiers of the processing-specific object semantics of the data object during instantiation.

10. The method according to claim 8, wherein the buffer controller extracts the semantic data from the data structure such that the semantic data form a subset of the data structure semantics and/or a subset of the object semantics, wherein the subset forms basic semantics of the data structure semantics and/or of the object semantics that are sufficient to instantiate the test data object with the payload data such that the test environment processes the payload data during the test.

11. The method according to claim 1, wherein the buffer is a temporary software application of the data processing environment that exists only during the transfer of the payload data or is a database application of the data management environment temporally independent of the transfer of payload data.

12. A data management environment comprising:
a buffer;
a buffer controller; and
a destination data store,
wherein the buffer controller is configured to:
provide in the buffer, a data record having payload data and semantic data, which are associated with the payload data, wherein the payload data are adapted for processing during development using a computer-assisted development environment connected with the destination data store of a control unit and/or of a system controlled or regulated by a control unit; and
instantiate a data object that is stored in the destination data store and includes processing-specific object semantics that allow a processing of the payload data by the development environment with the payload data based on the semantic data, wherein the payload data are placed in the data object as a function of the processing-specific object semantics such that the development environment processes the payload data during the development.

13. The data management environment according to claim 12, wherein the buffer controller is configured to:
provide as data record in the buffer, a test data record whose payload data are adapted for processing during a test by a test environment provided by the development environment of the control unit and/or of the controlled or regulated system; and
instantiate a test data object that is stored in the destination data store and includes test-specific object semantics that allow a processing of the payload data during the test, wherein the payload data are placed in the test data object as a function of the test-specific data object semantics such that the test environment processes the payload data during the test.

14. The data management environment according to claim 12, wherein the data management environment is configured to transfer the payload data to the destination data store.

15. The data management environment according to claim 12, further comprising a database with a destination data memory that is a component of the destination data store and in which the data object is stored, wherein the destination data memory is configured such that the development environment accesses the data object.

16. The data management environment according to claim 12, wherein the buffer controller is configured to extract the data record from a data structure that is stored in a source data memory that is a component of a source data store and configured to store the data record in the buffer, and wherein either the data processing environment includes the source data store and a database that includes the source data memory or the data processing environment is connected to the source data store such that the buffer controller accesses the source data memory.

17. The data management environment according to claim 16, wherein the buffer controller includes a source application and a destination application, wherein the source application is a component of the source data store and is configured to extract the data record from the data structure and store it in the buffer, and wherein the destination application is a component of the destination data store and is configured to instantiate the data object with the payload data of the data record.

18. The data management environment according to claim 17, wherein the data management environment is modular in design and includes a core module that provides the buffer and also includes a destination data storage module that includes the destination application and the destination data memory, wherein the data management environment additionally includes a source data storage module that includes the source application and the source data memory.

19. The data management environment according to claim 13, further comprising as a destination data storage module:
a test management module that is configured to instantiate the test data object with payload data such that the test environment processes the test data object for parameterization of the test and/or as variables of the test, or
a variable management module configured to instantiate the test data object with payload data such that the test environment processes the test data object as variables of the test;
or further comprising as a source data storage module:
a test specification module that is configured to provide in the data record payload data that the test environment processes via the destination data storage module for parameterization of the test, or
a variable management module that is configured to provide in the data record payload data that the test environment processes by the destination data storage module as variables of the test.

20. The data management environment according to claim 15, further comprising a client application and a server application, wherein the client application provides the buffer and the buffer controller, and wherein the server application implements accesses by the buffer controller to the database so that a user of the data management environment causes the transfer of the payload data to the destination data store through the client application.

21. The data management environment according to claim 20, wherein the data management environment is configured such that a user starts an individual client application with an individual buffer and an individual buffer controller, and wherein the client applications of the user are independent of client applications of other users.
